(19) United States
(12) Patent Application Publication
(10) Pub. No.: US 2022/0086996 A1
(43) Pub. Date: Mar. 17, 2022

(54) SYSTEM AND METHOD FOR PROVIDING A DIGITALLY SWITCHABLE X-RAY SOURCES

(71) Applicant: NANO-X IMAGING LTD., NEVE ILAN (IL)

(72) Inventors: AMIR BEN SHALOM, MODIIN (IL); LIOR GREENSTEIN, TEL AVIV (IL); GILAD DAVARA, REHOVOT (IL); GUSTI AVERBUCH, MODIIN (IL)

(21) Appl. No.: 17/419,725

(22) PCT Filed: Dec. 30, 2019
(86) PCT No.: PCT/IB2019/061434

§ 371 Date: Jun. 30, 2021

Related U.S. Application Data
(60) Provisional application No. 62/810,410, filed on Feb. 26, 2019.
(60) Provisional application No. 62/786,593, filed on Dec. 31, 2018.

(51) Int. Cl. H05G 1/46; H05G 1/32; H05G 1/40; H05G 1/56

(52) U.S. Cl. CPC H05G 1/46; H05G 1/56; H05G 1/40; H05G 1/32

(57) ABSTRACT

Systems and methods for digitally switching x-ray emission systems include a digital switching unit operable to selectively connect a low voltage driving circuit to activate a field emission type electron emitting construct such that electrons are accelerated by a high voltage towards an anode target thereby generating a pulse of x-rays. The x-ray pulses directed towards a scintillator are detected by an optical imager when its shutter is open. Shutter signals and the activation signals may be synchronized to produce required x-ray detection profiles.

### CROSS-REFERENCE TO RELATED APPLICATIONS

This application claims the benefit of priority from U.S. Provisional Patent Application No. 62/786,164, filed Dec. 31, 2018 and U.S. Provisional Patent Application No. 62/810,410, filed Feb. 26, 2019 the contents of which are incorporated by reference in their entirety.

### FIELD OF THE DISCLOSURE

The disclosure herein relates to systems and methods for providing digitally switchable x-ray sources. In particular, the disclosure relates to coordinating the switching of a low voltage driver to control emission of electron beams towards an anode target of an x-ray source.

### BACKGROUND

X-ray sources generally produce x-rays by accelerating a stream of electrons using a high voltage electric field towards an anode target. Typically the electron emitters of x-ray sources are hot filament cathodes. Such x-ray sources are difficult to control as the accelerating field requires high voltage and high voltage supplies are not readily switchable. Furthermore, hot filament cathodes have slow response times.

As a result typical x-ray sources may produce a steady stream of x-rays but because of the their long response times, they cannot produce x-ray pulses.

Thus, there is a need for controllable x-ray sources with fast response times. The invention described herein addresses the above-described needs.

### SUMMARY OF THE EMBODIMENTS

According to one aspect of the presently disclosed subject matter, a digitally switchable x-ray emission system is introduced. The digitally switchable x-ray emission system includes: a field emission type electron emitting construct; an anode target; a low voltage driving circuit for activating the electron emitting construct; and a high voltage supply for establishing an electron accelerating potential between the electron emitting construct and the anode. The system also includes a digital switching unit operable to selectively connect and disconnect the low voltage driving circuit thereby selectively activating and deactivating the field emission type electron emitting construct such that when the field emission type electron emitting construct is activated electrons are accelerated towards the anode target and a pulse of x-rays is generated. Variously, the system may further include a driver controller for controlling the switching unit. Additionally or alternatively, the system may include a timer for providing a fixed clock signal.

Optionally, the electron emitting construct comprises a gated cone electron source and gate electrode.

Where appropriate, the digital switching unit is operable to receive an activation signal from a controller. Optionally, the activation signal comprises a series of gate pulses generated at a regular intervals Δt and having a fixed gate-pulse duration δt1.

In various examples, a scintillator target is configured to fluoresce when the pulse of x-rays is incident thereupon. Accordingly, an optical imager may be configured and operable to detect florescence from the scintillator. Optionally, the optical imager comprises a triggered shutter operable to open when triggered by a shutter-pulse, for example by receiving a shutter signal from a shutter controller.

Accordingly, a shutter signal may include a series of trigger pulses generated at a regular intervals Δt and having a fixed shutter-pulse duration δt2. Where required, the synchronizer may be operable to synchronize a shutter signal comprising a series of trigger pulses having a fixed shutter-pulse duration δt2, with a driver signal comprising a series of gate pulses having a fixed gate-pulse duration δt1, and that the start of each shutter-pulse of the shutter signal is offset from the start of each gate-pulse by a phase shift φ such that the optical imager accumulates optical stimulation for a duration δt3 equal to the difference between the gate-pulse duration and the phase shift.

It is another aspect of the current disclosure to introduce a system for monitoring periodically moving mechanical components, the system comprising the digitally switchable x-ray emission system configured to generate periodic pulses of x-rays directed towards the periodically moving mechanical components wherein the controller is operable to generate an activation signal synchronized with the periodically moving mechanical components.

It is still another aspect of the current disclosure to introduce a multispectral x-ray source comprising the digitally switchable x-ray emission system wherein the high voltage supply is configured and operable to vary as a function over time and the low voltage driving circuit is operable to generate activation signals at times selected such that electrons are emitted with a required accelerating voltage thereby emitting x-rays with a required accelerating voltage.

In other aspects methods are taught for generating pulses of x-rays. Such methods may include: providing a digitally switchable x-ray emission system. The digitally switchable x-ray emission system may include: a field emission type electron emitting construct; an anode target; a low voltage driving circuit configured to provide a potential difference between a positive terminal wired to a gate electrode and a negative terminal wired to an array of electron sources of the electron emitting construct; a high voltage supply wired between said electron emitting construct and said anode; a digital switching unit operable to selectively connect and disconnect said low voltage driving circuit; a controller in communication with the digital switching unit.

The method may further include the high voltage supply establishing an electron accelerating potential between the electron emitting construct and the anode; the controller generating an activation signal comprising at least one gate pulses; sending the activation signal to the digital switching unit; and the digital switch unit activating the low voltage driving circuit to provide the potential difference between the gate electrode and the array of electron sources of the electron emitting construct for the duration of each gate pulse. Optionally, the controller generates a series of gate pulses generated at a regular intervals Δt and having a fixed gate-pulse duration δt1. Accordingly, the electron emitting construct may emit electrons; and the high voltage supply may accelerate the electrons towards the anode target such that the anode target generates x-rays for the duration of each gate pulse.

Where required, the method may also include: providing a scintillator target; providing an optical imager having a triggered shutter; providing a shutter controller; the shutter controller generating a shutter signal comprising a series of trigger pulses generated at a regular intervals Δt and having a fixed shutter-pulse duration δt2; sending the shutter signal to the optical imager; and the triggered shutter of the optical imager opening for the duration of each shutter-pulse.

Additionally, the method may include providing a synchronizer; the synchronizer synchronizing the activation signal with the shutter signal such that the start of each shutter-pulse is offset from the start of a gate-pulse by a phase shift ϕ; and the optical imager accumulating optical stimulation for a duration δt3 equal to the difference between the gate-pulse duration and the phase shift.

It is further noted that the synchronizer may also synchronize the activation signal with periodically moving mechanical components; and by directing the x-ray pulses towards the moving mechanical components. These may be monitored by stroboscopic x-ray pulses.

In particular examples the high voltage supply establishes an electron accelerating potential between the electron emitting construct and the anode by varying the accelerating potential over time. Accordingly, the controller may generate an activation signal by selecting a required accelerating potential; selecting a activation time at which the high voltage supply provides the required accelerating potential; and the step of sending the activation signal to the digital switching unit comprises sending gate pulse at the activation time.

### BRIEF DESCRIPTION OF THE FIGURES

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only, and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the various selected embodiments may be put into practice. In the accompanying drawings:

FIG. 1 is a block diagram representing selected elements of an embodiment of a switchable x-ray source;

FIG. 2 schematically represents a possible electron emitting construct for use in embodiments of the switchable x-ray source;

FIG. 3 is a block diagram representing of another embodiments of a switchable x-ray source incorporating an synchronized optical imager;

FIG. 4 illustrates possible signal profiles of a shutter signal and a gate signal and the resulting imaging rate acquired by an optical imager imaging an irradiated scintillator;

FIGS. 5A-C schematically represent another embodiment of the x-ray source incorporating an synchronized optical imager;

FIG. 6 is a graph illustrating how tube current varies with Filament current for a thermal emission x-ray tube; and

FIGS. 7A-E indicate various timing examples of synchronization signals.

### DETAILED DESCRIPTION

Aspects of the present disclosure relate to digitally switchable x-ray sources. In particular controlled stroboscopic x-ray sources are introduced which may enable regular periodic high frequency x-ray pulses which can be synchronized with other periodic signals.

In various embodiments of the disclosure, one or more tasks as described herein may be performed by a data processor, such as a computing platform or distributed computing system for executing a plurality of instructions. Optionally, the data processor includes or accesses a volatile memory for storing instructions, data or the like. Additionally, or alternatively, the data processor may access a non-volatile storage, for example, a magnetic hard-disk, flash-drive, removable media or the like, for storing instructions and/or data.

It is particularly noted that the systems and methods of the disclosure herein may not be limited in their application to the details of construction and the arrangement of the components or methods set forth in the description or illustrated in the drawings and examples. The systems and methods of the disclosure may be capable of other embodiments, or of being practiced and carried out in various ways and technologies.

Alternative methods and materials similar or equivalent to those described herein may be used in the practice or testing of embodiments of the disclosure. Nevertheless, particular methods and materials are described herein for illustrative purposes only. The materials, methods, and examples are not intended to be necessarily limiting.

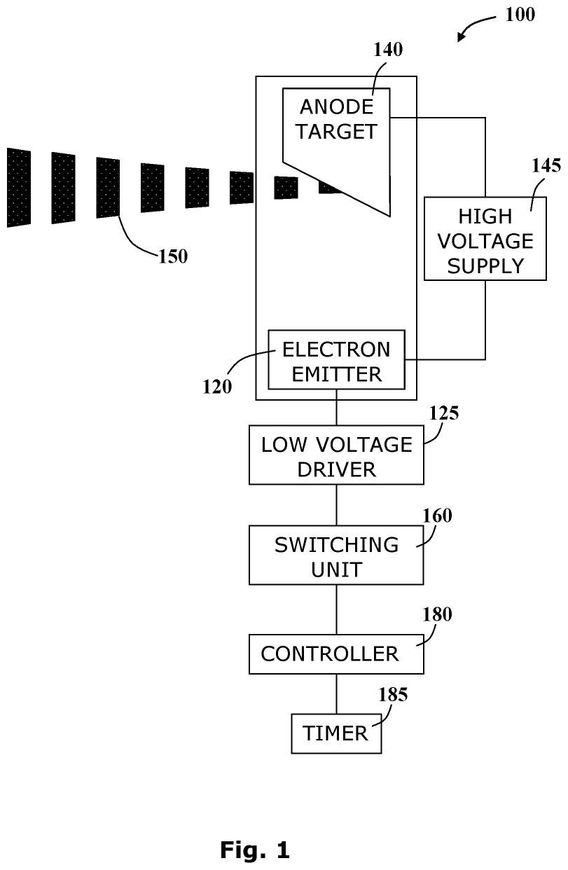

FIG. 1 is a block diagram representing selected elements of an embodiment of a switchable x-ray source 100. The digitally switchable x-ray emission system 100 includes an electron emitter 120, an anode target 140, a high voltage supply 145, a low voltage driver 125, a switching unit 160 a controller 180 and a timer 185.

The electron emitter 120 may be a cold cathode such as a low voltage activated field emission type electron emitting construct configured and operable to release electrons when stimulated by a low voltage. Accordingly, the low voltage driver 125 may include a low voltage driving circuit for activating the electron emitting construct;

The anode target 140 may comprise a metallic target selected such that x-rays 150 are generated when it is bombarded by accelerated electrons from the electron emitter 120. The anode 140 may be constructed of molybdenum, rhodium, tungsten, or the like or combinations thereof.

The high voltage supply 145 wired between said electron emitting construct 120 and the anode 140 is provided for establishing an electron accelerating potential between said electron emitting construct 120 and the anode 140.

It is a particular feature of the digitally switchable x-ray emission system 100 that the digital switching unit 160 is provided to selectively connect and disconnect the low voltage driving circuit 125 thereby selectively activating and deactivating the electron emitting construct 120. Accordingly, emission of the electrons may be controlled by the digital switching system 160.

When the emitting construct 120 is activated electrons are accelerated towards said anode target 140 and a pulse of x-rays 150 is generated. As a result, x-ray emission from the anode 140 may be controlled digitally by the switching unit 160.

The controller 180 may be provided to generate an activation signal which can control the switching rate of the digital switching unit 160. It is particularly noted that in contrast to high voltage switching systems, because the activation signal is a low voltage signal, the response time of the electron emitter is much shorter than the response time of switching the high voltage accelerating potential.

As a result of the reduced response time of the low voltage switching unit, a timer 185 may be provided to generate a fixed clock signal and a high frequency activation signal may be provided consisting of a series of short duration gate pulses at regular intervals.

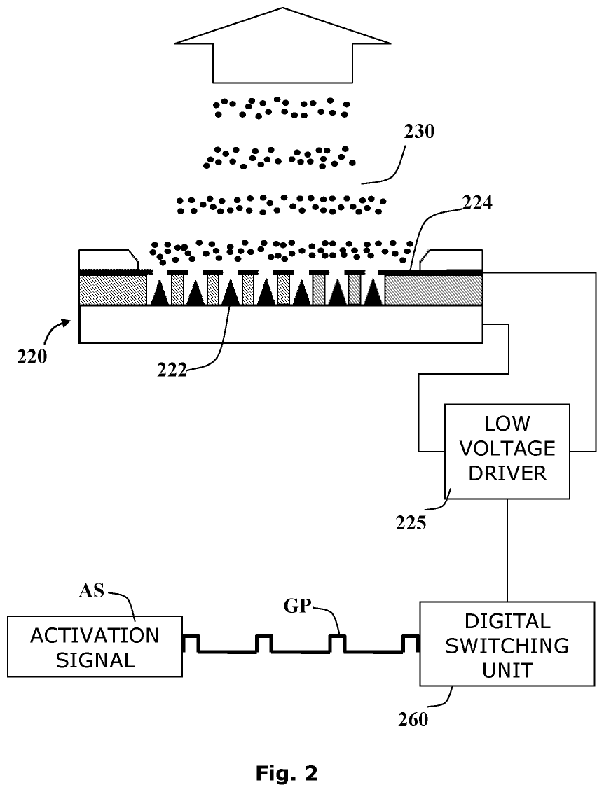

Referring now to FIG. 2, which schematically represents a possible electron emitting construct 120 for use in embodiments of the switchable x-ray source. A field emission type electron source 122 may be electrically connected to a driving circuit 225 via a signal line and further electrically connected to a gate electrode 224. The coordinated electrical activation of the driving circuit and the gate electrode 224 connected to a field emission type electron source 222 results in its activation, i.e., electron emission. The field emission type electron source 222 performs the electron emission 230 by an electric field formed between the field emission type electron source 222 and the gate electrode 224.

The field emission type electron source 222 may be, e.g., a Spindt type electron source, a carbon nanotube (CNT) type electron source, a metal-insulator-metal (MIM) type electron source or a metal-insulator-semiconductor (MIS) type electron source. In a preferred embodiment, the electron source 222 may be a Spindt type electron source.

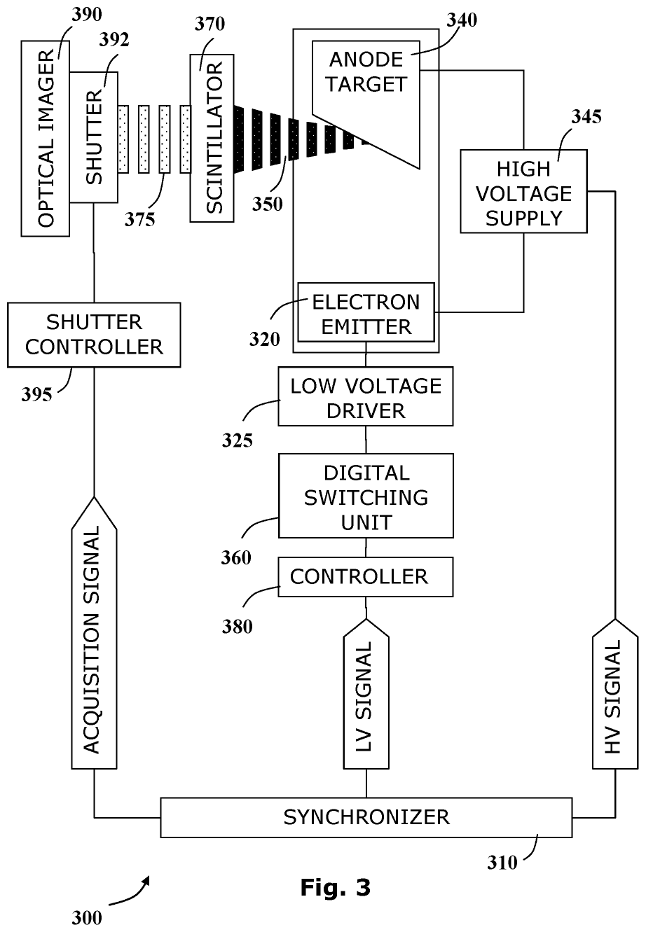

The activation signal AS may comprise a series of gate pulses GS generated at a regular intervals At and having a fixed gate-pulse duration δt1. Accordingly, the electron emission 230 may follow a similar regular pattern of emission. With reference to the block diagram of FIG. 3 which represents another embodiment of a switchable x-ray source 300 incorporating an synchronized optical imager 390.

The x-rays 350 emitted by the x-ray source 340 may be directed towards a scintillator 370 such that the scintillator 370 fluoresces when a pulse of x-rays 350 is incident thereupon. The optical imager 390 is configured and operable to detect florescence 375 from the scintillator 370 when its shutter 392 is open. A shutter controller 395 is provided to trigger the shutter 392 of the optical imager when a shutter pulse is received.

It is noted that a synchronizer 310 may be provided to synchronize a shutter signal with the electron emission activation signal to further control the imaging duration of the system. Accordingly, the synchronizer may be operable to coordinate a high voltage (HV) signal, a low voltage (LV) signal and an acquisition signal.

The high voltage signal may be a function over time determining the characteristics of the high voltage amplitude of the electron accelerating potential produced by the high voltage supply 345. The signal profile of the HV signal may be controlled by the synchronizer 310 and coordinated with the LV signal and the acquisition signal to control the imaging rate of an x-ray device 300.

The low voltage signal may be a function over time determining the characteristics of the switching rate determined by the controller 380 of the digital switching unit 360. The digital switching unit 360 accordingly may activate the low voltage driver 325 for producing the low voltage activation potential provided to the electron emitting construct 320. The LV signal profile may be controlled by the synchronizer 310 and coordinated with the HV signal and the acquisition signal to control the imaging rate of an x-ray device.

The acquisition signal may be a function over time determining the sampling rate of the optical imager 390. Accordingly, by controlling the acquisition signal and coordinating it with the HV signal and the LV signal the synchronizer 310 may control the imaging rate of an x-ray device 300.

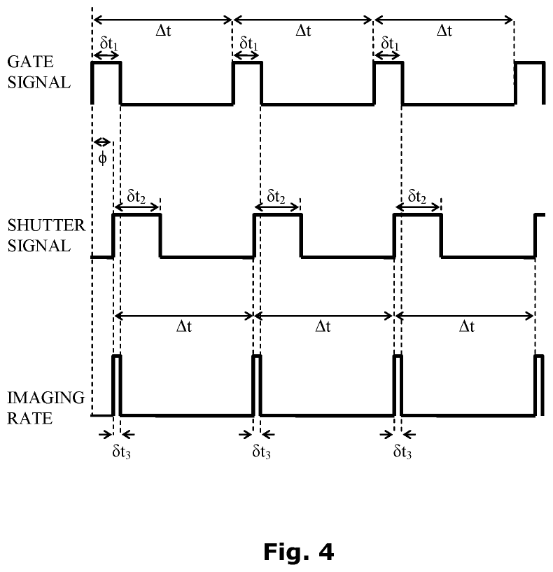

FIG. 4 illustrates possible signal profiles of a shutter signal and a gate signal and the resulting imaging rate acquired by an optical imager imaging an irradiated scintillator. The Gate Signal comprises a series of gate pulses generated at a regular intervals At and having a fixed gate-pulse duration δt1. The Shutter Signal has the same frequency and consists of a phase shifted series of trigger pulses generated at the same regular intervals At and having a fixed shutter-pulse duration δt2. The Gate Signal may be synchronized to the shutter signal such that the start of each shutter-pulse of the shutter signal is offset from the start of each gate-pulse by a phase shift 4). Accordingly, the imaging rate is determined by the frequency (same At intervals) but the effective exposure time during which the optical imager accumulates optical stimulation is determined by the overlap between the two signals δt3.

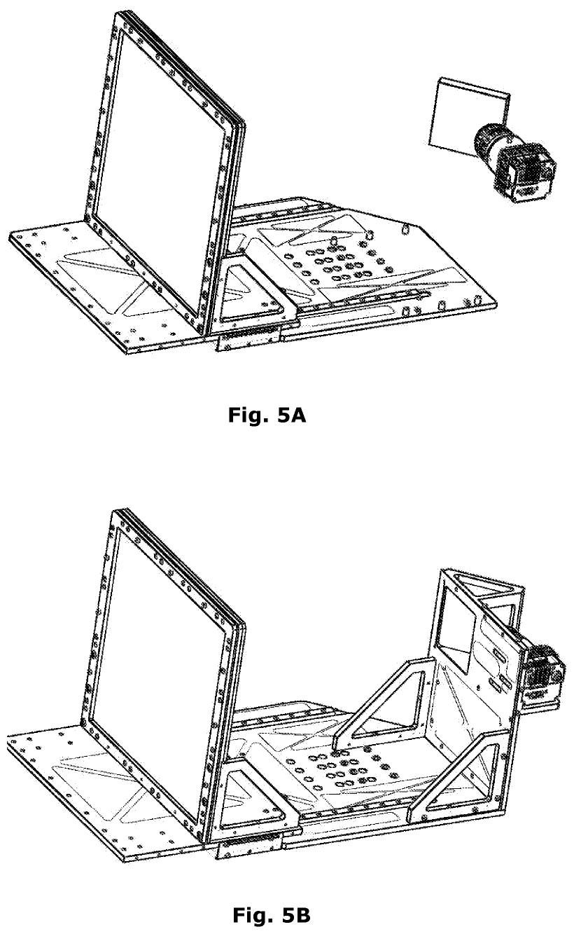

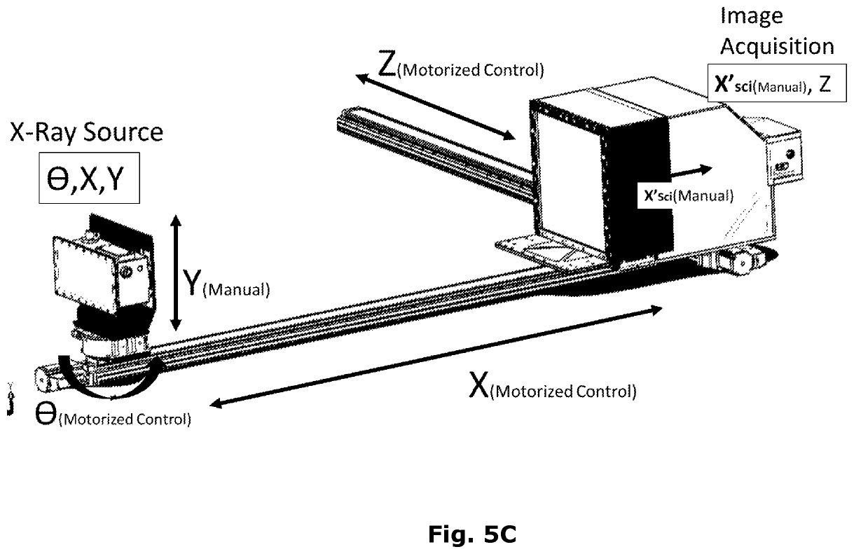

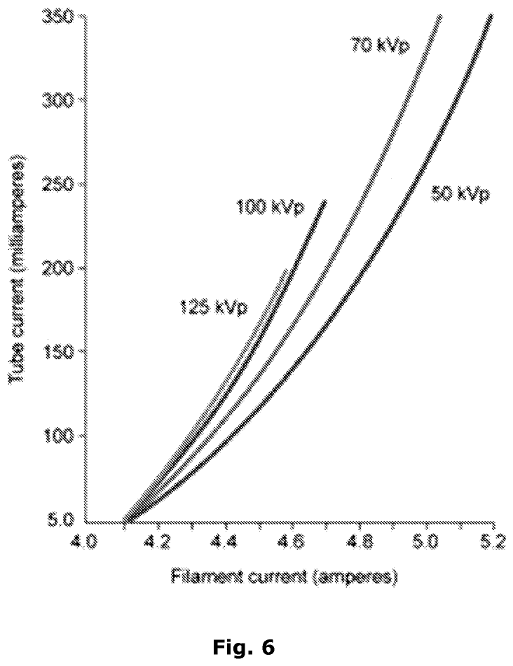

FIGS. 5A-C schematically represent another embodiment of the x-ray source incorporating a synchronized optical imager. FIG. 5A shows an image acquisition unit including a scintillator target, and optical imager configured such that the scintillator target forms an angle of forty-five degrees to both the optical imager and the. FIG. 5B shows a housing configured to secure the scintillator target and the optical imager at the desired angle. FIG. 5C shows how the image acquisition may be configured to receive x-rays from an x-ray source.

It is noted that a field emission (FE) cathode by contrast to standard hot filament x-ray sources have a gate electrode which is operable at relatively low voltages of only tens of volts This gate electrode, practically “ejects” the electrons from the cathode and control the amount of x-ray radiation.

This enables the x-ray power (mA tube current) to be controlled separately from the accelerating voltage (KVp). In thermal emission, the tube current depends upon the high voltage potential difference and on the filament temperature (see example plot in FIG. 6). Such a current can stabilized/changed very slowly in the second scale. In field emission sources, tube current can be set by the gate voltage level that can change rapidly on a microsecond scale.

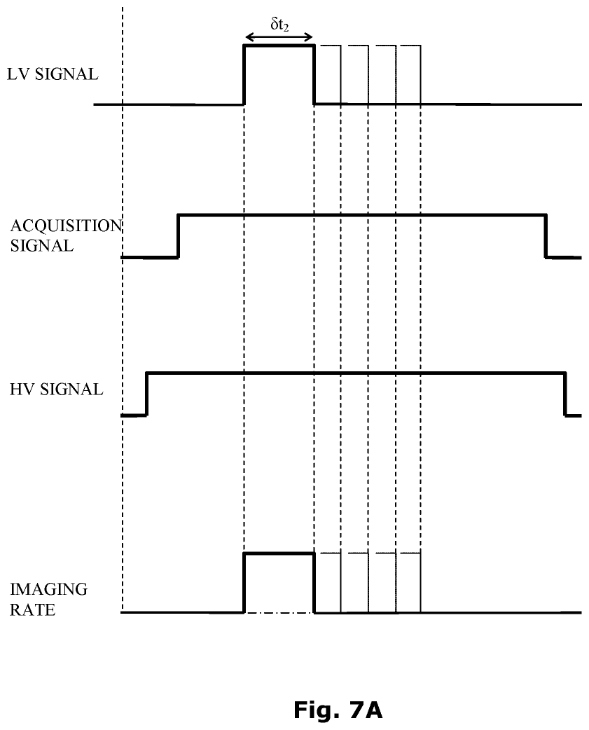

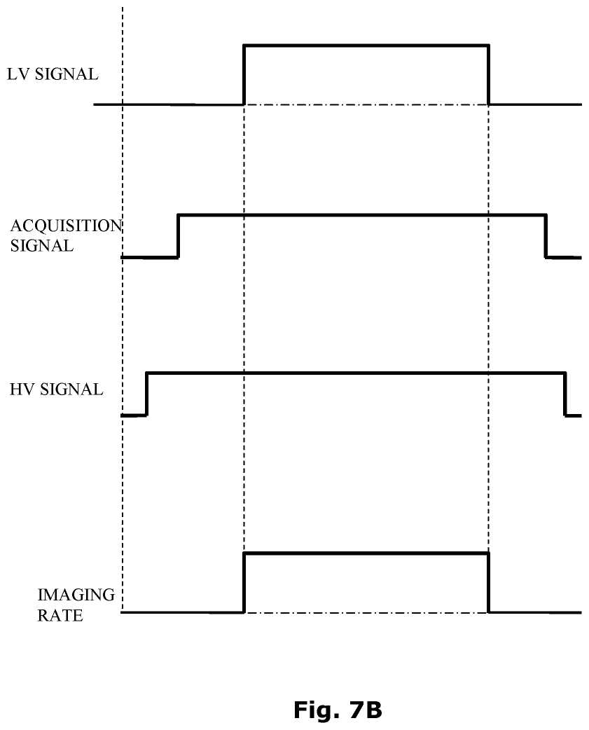

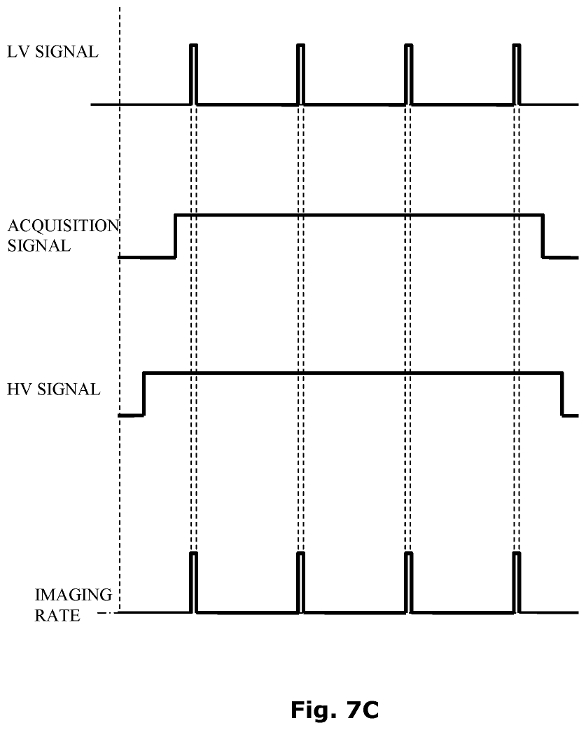

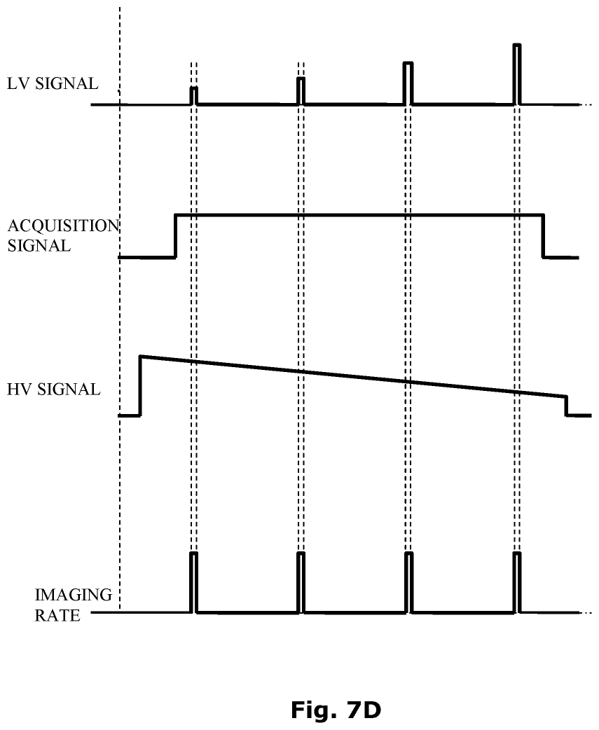

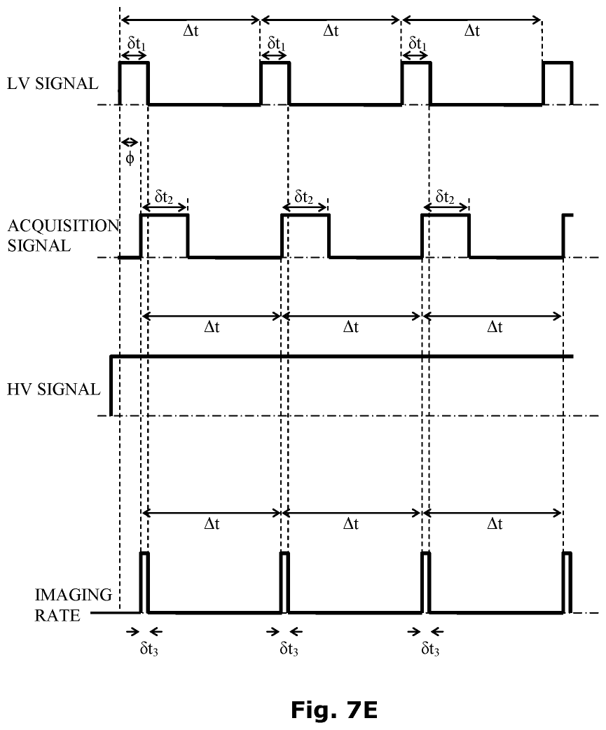

Short, accurate and synchronized gate pulses (at fixed or variable voltage levels=variable mA). The synchronization can be to the sensor/detector/camera “shutter” and/or to a vibrating/rotating examine object. The short pulses yield sharp image (even at high speed movement) and Integration of many synchronized pulses compensate the low energy/brightness of each pulse. See examples of timing diagrams in FIGS. 7A-E.

FIGS. 7A and 7B illustrate how where the duration of a gate pulse is smaller than the duration of the shutter pulse, the effective exposure time may be determined by the duration of the gate pulse regardless of the duration of the High Voltage Acceleration pulse.

FIG. 7C illustrates how a series of LV signal pulses may be used to generate a pulsed imaging rate. It will be appreciated that such a signal may enable an x-ray device to function in a stroboscopic manner.

FIG. 7D illustrates an HV signal having a gradient over time. It is particularly noted that by providing an HV signal having a gradient over time, a number of applications may be possible such as a multispectral device operable to distinguish between materials according to their characteristic x-ray absorption rates.

A multispectral device may be used, for example to identify both soft materials, such as drugs as well as hard materials such as metals. Accordingly, using a multispectral x-ray imager may allow a single device to be used to detect both drugs and weapons for security purposes.

Furthermore, in medical applications, tissue maybe differentiated according to their absorption rates. Thus it may be possible to identify rogue bodies such as cancer cells against a background of normal tissue.

In still other applications, the HV signal may be varied to compensate for bodies of varying thickness. So, for example, in a mammogram, the HV signal may be increased and decreased according to the contours of the breast.

FIG. 7D further illustrates how synchronized variation in the low voltage gate signal may compensate for variation in the high voltage acceleration signal such that a constant imaging rate may be maintained,

It is further noted that by the low voltage signal may also be adjusted to compensate for damaged emitters so as to produce a consistent performance of the device over time. Accordingly, any or all of the amplitude, duty cycle and/or frequency or the like may be controlled in order to adjust the LV signal.

Furthermore, self-diagnosis of the x-ray device may be enabled by measuring cathode current, measured between the cathode and the gate electrode, and anode current, measured between the cathode and the anode. Accordingly, electron leakage from the tube may be detected by comparing the measured cathode current and the measured anode current. For example, by monitoring the difference between the measured values or the quotient of the measured values, a leakage index may be calculated indicating the health of the system.

FIGS. 4 and 7E illustrate possible signal profiles of a shutter signal and a gate signal and the resulting imaging rate acquired by an optical imager imaging an irradiated scintillator. The Activation Signal or Gate Signal is the LV signal triggering the electron emitting construct which has a square profile of comprises a series of gate pulses generated at a regular intervals Δt and having a fixed gate-pulse duration δt1.

The Shutter Signal has the same frequency and consists of a phase shifted series of trigger pulses generated at the same regular intervals Δt and having a fixed shutter-pulse duration δt2. The Activation Signal is synchronized to the shutter signal such that the start of each shutter-pulse of the shutter signal is offset from the start of each gate-pulse by a phase shift ϕ. Accordingly, the imaging rate is determined by the frequency (same At intervals) but the effective exposure time during which the optical imager accumulates optical stimulation is determined by the overlap between the two signals. It is particularly noted that the effective exposure time δt3 may set to be as short as possible regardless of the pulse and/or shutter time.

Various applications of the above described system include using fast and synchronized x-ray pulses for nondestructive stroboscopic industrial radiography tests, for example, inspection of rotating objects and vibration tests.

For example, in airplanes/engines/jet indurates this idea can be used for crack detection in real time in mechanical/rotating loads. Additionally or alternatively accurate examination of rotating objects (the blades) may be possible without removal of their covers using an external x-ray machine.

Accordingly, a method is taught for monitoring periodically moving mechanical components. Such a method includes

The method may further include the high voltage supply establishing an electron accelerating potential between said electron emitting construct and said anode; the controller generating an activation signal comprising a series of gate pulses generated at a regular intervals At and having a fixed gate-pulse duration δt1; the shutter controller generating a shutter signal comprising a series of trigger pulses generated at a regular intervals At and having a fixed shutter-pulse duration δt2; the synchronizer synchronizing the activation signal with the shutter signal such that the start of each shutter-pulse is offset from the start of a gate-pulse by a phase shift ϕ; and the synchronizer synchronizing the activation signal with the periodically moving mechanical components; sending the activation signal to the digital switching unit.

Accordingly, the method may still further include the digital switch unit activating the low voltage driving circuit to provide the potential difference between the gate electrode and the array of electron sources of the electron emitting construct for the duration of each gate pulse; the electron emitting construct emitting electrons; the high voltage supply accelerating the electrons towards the anode target; and the anode target generating x-rays for the duration of each gate pulse.

Further the x-ray pulses may be directed towards the moving mechanical components; the shutter signal may be sent to the optical imager such that the triggered shutter of the optical imager opens for the duration of each shutter-pulse; and the optical imager accumulates optical stimulation for a duration δt3 equal to the difference between the gate-pulse duration and the phase shift.

### Technical Notes

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of the terms such as computing unit, network, display, memory, server and the like are intended to include all such new technologies a priori.

As used herein the term “about” refers to at least ±10%.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. It should be understood, therefore, that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments unless the embodiment is inoperative without those elements.

Although the disclosure has been described in conjunction with specific embodiments thereof, it is evident that many alternatives, modifications and variations will be apparent to those skilled in the art.

Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

The scope of the disclosed subject matter is defined by the appended claims and includes both combinations and sub combinations of the various features described hereinabove as well as variations and modifications thereof, which would occur to persons skilled in the art upon reading the foregoing description.

1. A digitally switchable x-ray emission system comprising:
a field emission type electron emitting construct;
an anode target;
a low voltage driving circuit for activating said electron emitting construct; and
a high voltage supply for establishing an electron accelerating potential between said electron emitting construct and said anode;
wherein said system further comprises a digital switching unit operable to selectively connect and disconnect said low voltage driving circuit thereby selectively activating and deactivating said field emission type electron emitting construct such that when said field emission type electron emitting construct is activated electrons are accelerated towards said anode target and a pulse of x-rays is generated.

2. The system of claim 1 wherein said digital switching unit is operable to receive an activation signal from a controller.

3. The system of claim 2 wherein said activation signal comprises a series of gate pulses generated at a regular intervals At and having a fixed gate-pulse duration δt1.

4. The system of claim 1 further comprising a driver controller for controlling the switching unit.

5. The system of claim 1 further comprising a timer for providing a fixed clock signal.

6. The system of claim 1 wherein said electron emitting construct comprises a gated cone electron source and gate electrode.

7. The system of claim 1 further comprising a scintillator target configured to fluoresce when said pulse of x-rays is incident thereupon.

8. The system of claim 1 further comprising an optical imager configured and operable to detect florescence from said scintillator, said optical imager comprises a triggered shutter operable to open when triggered by a shutter-pulse.

9. (canceled)

10. The system of claim 1 wherein said optical imager comprises a triggered shutter operable to receive a shutter signal from a shutter controller.

11. The system of claim 10 wherein said shutter signal comprises a series of trigger pulses generated at a regular intervals At and having a fixed shutter-pulse duration δt2.

12. The system of claim 1 further comprising a synchronizer operable to synchronize a shutter signal comprising a series of trigger pulses having a fixed shutter-pulse duration δt2, with a driver signal comprising a series of gate pulses having a fixed gate-pulse duration δt1, and that the start of each shutter-pulse of the shutter signal is offset from the start of each gate-pulse by a phase shift ϕ such that the optical imager accumulates optical stimulation for a duration δt3 equal to the difference between the gate-pulse duration and the phase shift.

13. A system for monitoring periodically moving mechanical components, the system comprising the digitally switchable x-ray emission system of claim 3 configured to generate periodic pulses of x-rays directed towards the periodically moving mechanical components wherein the controller is operable to generate an activation signal synchronized with the periodically moving mechanical components.

14. A multispectral x-ray source comprising the digitally switchable x-ray emission system of claim 1 wherein the high voltage supply is configured and operable to vary as a function over time and the low voltage driving circuit is operable to generate activation signals at times selected such that electrons are emitted with a required accelerating voltage thereby emitting x-rays with a required accelerating voltage.

15. A method for generating pulses of x-rays, the method comprising:
providing a digitally switchable x-ray emission system comprising:
a field emission type electron emitting construct;
an anode target;
a low voltage driving circuit configured to provide a potential difference between a positive terminal wired to a gate electrode and a negative terminal wired to an array of electron sources of the electron emitting construct;
a high voltage supply wired between said electron emitting construct and said anode;
a digital switching unit operable to selectively connect and disconnect said low voltage driving circuit; and
a controller in communication with the digital switching unit;
the high voltage supply establishing an electron accelerating potential between said electron emitting construct and said anode;
the controller generating an activation signal comprising at least one gate pulses;
sending the activation signal to the digital switching unit;
the digital switch unit activating the low voltage driving circuit to provide the potential difference between the gate electrode and the array of electron sources of the electron emitting construct for the duration of each gate pulse;
the electron emitting construct emitting electrons;
the high voltage supply accelerating the electrons towards the anode target; and
the anode target generating x-rays for the duration of each gate pulse.

16. The method of claim 15 wherein the step of the controller generating an activation signal comprises:
generating a series of gate pulses generated at a regular intervals Δt and having a fixed gate-pulse duration δt1.

17. The method of claim 16 further comprising:
providing a scintillator target;
providing an optical imager having a triggered shutter;
providing a shutter controller;
the shutter controller generating a shutter signal comprising a series of trigger pulses generated at a regular intervals Δt and having a fixed shutter-pulse duration δt2;
sending the shutter signal to the optical imager; and
the triggered shutter of the optical imager opening for the duration of each shutter-pulse.

18. The method of claim 17 further comprising:
providing a synchronizer;
the synchronizer synchronizing the activation signal with the shutter signal such that the start of each shutter-pulse is offset from the start of a gate-pulse by a phase shift ϕ; and
the optical imager accumulating optical stimulation for a duration δt3 equal to the difference between the gate-pulse duration and the phase shift.

19. The method of claim 15 wherein:
the step of the high voltage supply establishing an electron accelerating potential between said electron emitting construct and said anode comprises varying the accelerating potential over time;
the step of the controller generating an activation signal comprises:
selecting a required accelerating potential;
selecting a activation time at which the high voltage supply provides the required accelerating potential; and
the step of sending the activation signal to the digital switching unit comprises sending gate pulse at the activation time.

20. The method of claim 16 further comprising a
providing a synchronizer;
the synchronizer synchronizing the activation signal with periodically moving mechanical components; and
directing the x-ray pulses towards the moving mechanical components.

21. A method for monitoring periodically moving mechanical components, the method comprising:
providing a digitally switchable x-ray emission system comprising:
a field emission type electron emitting construct;
an anode target;
a low voltage driving circuit configured to provide a potential difference between a positive terminal wired to a gate electrode and a negative terminal wired to an array of electron sources of the electron emitting construct;
a high voltage supply wired between said electron emitting construct and said anode;
a digital switching unit operable to selectively connect and disconnect said low voltage driving circuit;
a controller in communication with the digital switching unit; and
providing a scintillator target;
providing an optical imager having a triggered shutter;
providing a shutter controller;
providing a synchronizer;
the high voltage supply establishing an electron accelerating potential between said electron emitting construct and said anode;
the controller generating an activation signal comprising a series of gate pulses generated at a regular intervals At and having a fixed gate-pulse duration δt1;
the shutter controller generating a shutter signal comprising a series of trigger pulses generated at a regular intervals At and having a fixed shutter-pulse duration δt2;
the synchronizer synchronizing the activation signal with the shutter signal such that the start of each shutter-pulse is offset from the start of a gate-pulse by a phase shift ϕ;
the synchronizer synchronizing the activation signal with the periodically moving mechanical components;
sending the activation signal to the digital switching unit;
the digital switch unit activating the low voltage driving circuit to provide the potential difference between the gate electrode and the array of electron sources of the electron emitting construct for the duration of each gate pulse;
the electron emitting construct emitting electrons;
the high voltage supply accelerating the electrons towards the anode target;
the anode target generating x-rays for the duration of each gate pulse;
directing the x-ray pulses towards the moving mechanical components;
sending the shutter signal to the optical imager;
the triggered shutter of the optical imager opening for the duration of each shutter-pulse; and
the optical imager accumulating optical stimulation for a duration δt3 equal to the difference between the gate-pulse duration and the phase shift.
